(19) United States
(12) Patent Application Publication
(10) Pub. No.: US 2025/0245322 A1
(43) Pub. Date: Jul. 31, 2025

(54) MONITORING DEVICE, MONITORING METHOD, AND RECORDING MEDIUM

(71) Applicant: Panasonic Automotive Systems Co., Ltd., Kanagawa (JP)

(72) Inventors: Nobutaka KAWAGUCHI, Osaka (JP); Kaoru YOKOTA, Hyogo (JP); Yoji TAKANO, Osaka (JP)

(73) Assignee: Panasonic Automotive Systems Co., Ltd., Kanagawa (JP)

(21) Appl. No.: 19/020,902

(22) Filed: Jan. 14, 2025

(30) Foreign Application Priority Data
Jan. 31, 2024 (JP) 2024-012692
Jun. 4, 2024 (JP) 2024-090876

(51) Int. Cl. G06F 21/55; G06F 12/14; G06F 21/78

(52) U.S. Cl. CPC G06F 21/552; G06F 12/14; G06F 21/78

(57) ABSTRACT

A monitoring device is a monitoring device that monitors a monitoring target that exists in a normal world. The monitoring target is also monitored by an other monitoring device different from the monitoring device. The monitoring device includes: an obtainer that obtains, when the other monitoring device causes restarting of a system based on a result of monitoring the monitoring target, a monitoring request from the monitoring target after the restarting, the system including the monitoring target and the monitoring device; and a determiner that, in response to receiving the monitoring request, determines whether to resume the monitoring of the monitoring target.

### CROSS REFERENCE TO RELATED APPLICATION

The present application is based on and claims priority of Japanese Patent Application No. 2024-012692 filed on Jan. 31, 2024 and Japanese Patent Application No. 2024-090876 filed on Jun. 4, 2024.

### FIELD

The present disclosure relates to a monitoring device, a monitoring method, and a recording medium.

### BACKGROUND ART

Conventionally, a plurality of electronic control devices that are interconnected via an in-vehicle network are provided in an automobile. When some kind of anomaly occurs in these electronic control devices, there is a demand for identifying the cause of the anomaly by collecting and analyzing various related to the operation of the electronic control device. Patent Literature (PTL 1) discloses an electronic control device that uses virtualization technology and which, when an anomaly occurs in the electronic control device, can collect, in a high security region, a log related to the anomaly.

### CITATION LIST

### Patent Literature

PTL 1: Japanese Unexamined Patent Application Publication No. 2020-129238

### SUMMARY

Incidentally, the monitoring devices, and the like, can be improved upon.

In view of this, the present disclosure provides a monitoring device, a monitoring method, and a recording medium that are capable of improving upon the above related art.

A monitoring device according to an aspect of the present disclosure is a monitoring device that monitors a monitoring target that exists in a normal world, wherein the monitoring target is also monitored by an other monitoring device different from the monitoring device, and the monitoring device includes: an obtainer that obtains, when the other monitoring device causes restarting of a system based on a result of monitoring the monitoring target, a monitoring request from the monitoring target after the restarting, the system including the monitoring target and the monitoring device; and a determiner that, in response to receiving the monitoring request, determines whether to resume the monitoring of the monitoring target.

A monitoring method according to an aspect of the present disclosure is monitoring method executed by a monitoring device that monitors a monitoring target that exists in a normal world, wherein the monitoring target is also monitored by an other monitoring device different from the monitoring device, and the monitoring method includes: obtaining, when the other monitoring device causes restarting of a system based on a result of monitoring the monitoring target, a monitoring request from the monitoring target after the restarting, the system including the monitoring target and the monitoring device; and in response to receiving the monitoring request, determining whether to resume the monitoring of the monitoring target.

A recording medium according to an aspect of the present disclosure is a non-transitory computer-readable recording medium having recorded thereon a program for causing a computer to execute the above-described monitoring method.

According to an aspect of the present disclosure, it is possible to realize a monitoring device, and the like, that is capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram illustrating the configuration of a monitoring system according to an embodiment.

FIG. 2 is a block diagram illustrating the functional configuration of a second monitor according to the embodiment.

FIG. 3 is a flowchart illustrating the operation of the second monitor according to the embodiment.

FIG. 4 is a flowchart illustrating the detailed operation in step S50 illustrated in FIG. 3.

FIG. 5 is a flowchart illustrating the operation of a first monitor according to the embodiment.

### DESCRIPTION OF EMBODIMENTS

### (Circumstances Leading to the Present Disclosure)

In an electronic control device, in addition to a monitoring device that monitors a monitoring subject, there are cases where another monitoring device is provided. In this case, when the other monitoring device detects an anomaly in the monitoring subject and restarts the system including the monitoring target and the monitoring device, there are cases where the monitoring target is excluded from the monitoring by the monitoring device after restarting.

In view of this, the present disclosure provides, as further improvement on the related art, a monitoring device, a monitoring method, and a program that are capable of preventing the monitoring target from being excluded from the monitoring by the monitoring device even when the system is restarted by the other monitoring device.

It should be noted that each of the embodiments described below shows a general or specific example. The numerical values, shapes, elements, the arrangement and connection of the elements, steps, the processing order of the steps, etc., indicated in the following embodiments are mere examples, and thus are not intended to limit the present disclosure. Furthermore, among the elements described in the following embodiments, elements not described in any one of the independent claims are described as optional elements.

Furthermore, the respective figures are schematic diagrams and are not necessarily precise illustrations. Therefore, for example, the scaling, and so on, depicted in the drawings is not necessarily uniform. Furthermore, in the figures, elements which are substantially the same are given the same reference signs, and overlapping description is omitted or simplified.

Additionally, in the present description, terms indicating relations between elements, such as “match”, as well as numerical values and numerical ranges, are not strictly defined and include a substantially same range or a margin of error of a few percent (or about 10 percent).

### Embodiment

Hereinafter, a monitoring system including a monitoring device according to the present embodiment, and so on, will be described.

### [1. Configuration of Monitoring System]

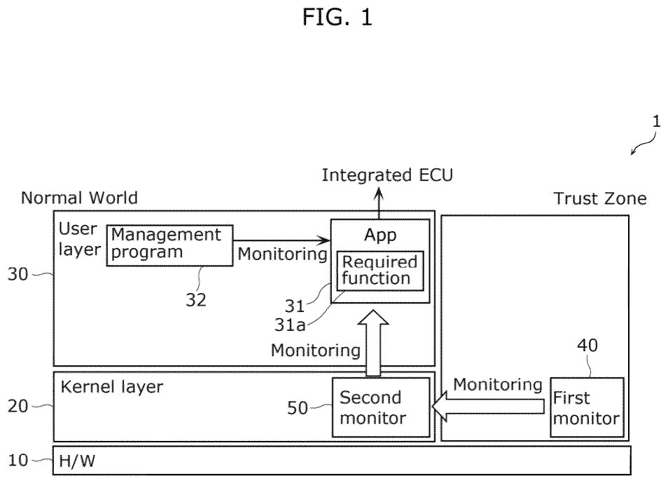

FIG. 1 is a diagram illustrating a configuration of monitoring system 1 according to the present embodiment. Monitoring system 1 is a system for monitoring a monitoring target provided in a vehicle. Monitoring system 1 is realized by, for example, an electronic control unit (ECU), which is a computer provided in the vehicle and includes a processor (microprocessor), a memory, and the like. The memory is, for example, a read only memory (ROM) and a random access memory (RAM). The memory is capable of storing a program to be executed by the processor.

As illustrated in FIG. 1, monitoring system 1 includes hardware 10 (H/W in FIG. 1), and kernel layer 20 and user layer 30 that constitute an operating system (OS) hierarchy. Kernel layer 20 and user layer 30 are provided in a normal world (insecure area), which is different from a trust zone. The trust zone is a secure area that limits access from the normal world where an OS and an application operate. Furthermore, in the present embodiment, an example in which software of monitoring system 1 operates on a Linux (R) (the same applies below) OS will be described. However, this is not limiting.

Hardware 10 is a chip (e.g., system on chip (SoC)) and represents a machine or a device that is capable of receiving data, performing logical operations on data, storing data, and displaying data. However, hardware 10 is not limited to this. Hardware 10 may include a processor and a memory. Furthermore, kernel layer 20 operates on the chip, and user layer 30 operates on kernel layer 20. Kernel layer 20 is also referred to as a kernel space. Furthermore, user layer 30 is also referred to as a user space. User layer 30 is a layer where actions that can be executed are limited compared with kernel layer 20.

Kernel layer 20 includes second monitor 50 as well as a kernel (not illustrated), which is software playing a role of basic functions of the OS. User layer 30 includes an application program and the like for realizing various functions. In the present embodiment, user layer 30 includes application unit 31 including the application program (hereinafter, also referred to as app) (App in FIG. 1) and includes management program 32. It should be noted that the number of application units 31 present in user layer 30 (i.e., the number of apps) may be any number greater than or equal to one.

Application unit 31 includes, for example, one or more processes and a memory for the one or more processes. The processes are each an executable unit for a program to be executed by application unit 31. Examples of the app include, but not limited to, an app for realizing WiFi (R) communication, an app for realizing Bluetooth (R) communication, an app that controls an image to be displayed to a person who is in the vehicle (e.g., an app for in-vehicle infotainment (IVI)), and an app pertaining to controlling the vehicle (e.g., an app for realizing automated driving function). Functions realized by the apps are set as appropriate in accordance with an object that is provided with monitoring system 1.

Application unit 31 is a monitoring target of second monitor 50. Specifically, the one or more processes included in application unit 31 and the memory are monitoring target of second monitor 50. Furthermore, application unit 31 is also monitored by management program 32.

Application unit 31 exists in the normal world, which is not robust from a security perspective, and its process may fail to operate normally due to an attack from the outside or the like. Furthermore, a process of application unit 31 may also fail to operate normally due to a factor that is not security-related.

It should be noted that application unit 31 may be capable of communicating with an integrated ECU provided in the vehicle. The integrated ECU is an ECU that takes a central role for zone ECUs to control the entire vehicle.

Management program 32 is a program for starting and monitoring application unit 31 (e.g., a program executed as basic functions of the OS). Management program 32 and an execution unit (not illustrated) of such management program 32 are each an example of another monitoring device. That is, the other monitoring device is configured to be capable of executing management program 32 in the normal world (specifically, user layer 30). In the present embodiment, the other monitoring device is realized as a monitoring function of the OS (e.g., Linux) that operates in monitoring system 1.

Management program 32 monitors application unit 31 independently of second monitor 50. In addition, management program 32 has a function of restarting monitoring system 1 as a whole without notifying second monitor 50 when detecting that a process fails to operate normally (an example of a result of monitoring). That is, management program 32 can restart monitoring system 1 independently of second monitor 50 and does not notify second monitor 50 of the restart. Management program 32 may be a program such as “systemd” in a Unix-like computer, such as Linux.

It should be noted that targets of the restart here include, in addition to application unit 31, all of another app in user layer 30, kernel layer 20, and hardware 10 and the like. First monitor 40 and second monitor 50 are also included in the targets of the restart. That is, the restart means restarting monitoring system 1 as a whole. Hereinafter, restarting monitoring system 1 will also be referred to as system reset.

It should be noted that Linux has such a mechanism that information on it in a memory is changed with every restart. Accordingly, after management program 32 performs the restart, while management program 32 continues to monitor application unit 31, application unit 31 is excluded from monitoring by second monitor 50. That is, the security of a monitoring target may decrease after the restart. Thus, application unit 31 includes required function 31a, which is a function of issuing a monitoring request to resume monitoring to second monitor 50. That is, application unit 31 includes a program that can execute such required function 31a.

Required function 31a issues the monitoring request to second monitor 50 after such application unit 31 has been restarted or has been restored from a failure. It should be noted that required function 31a may determine whether the restart has been executed by any one of second monitor 50 or management program 32, and when the restart has been executed by management program 32, required function 31a may issue a monitoring request to second monitor 50. Furthermore, when application unit 31 is restored from a failure state, required function 31a may issue a monitoring request to second monitor 50 irrespective of whether the restart has been executed.

Second monitor 50 is a monitoring device that monitors a monitoring target existing in the normal world, such as an app. It can be said that second monitor 50 monitors an app or the like operating in user layer 30. In the present embodiment, second monitor 50 monitors the one or more processes of application unit 31 individually. Second monitor 50 monitors whether the one or more processes of application unit 31 are alive and whether the memory in application unit 31 (e.g., memories for the one or more processes) has been tampered with. Second monitor 50 determines whether to resume the monitoring based on a process count of the monitoring target (here, application unit 31), which will be described in detail later.

It should be noted that, when monitoring system 1 is restarted by management program 32, second monitor 50 cannot grasp the timing of the restart. This is also a factor of excluding application unit 31 from the monitoring by second monitor 50.

Here, Linux has such a mechanism that manages any existing process on its own. With the mechanism, Linux determines whether the one or more processes of application unit 31 exist one by one. For example, for every process included in all application units 31 in user layer 30, Linux determines whether the process exists at predetermined time intervals. The existence may include, for example, operating normally.

Second monitor 50 obtains information about the aliveness of each of the one or more processes of each application unit 31, which is determined by the mechanism in Linux, and determines whether the one or more processes of application units 31 are alive based on the obtained information. It should be noted that second monitor 50 may be configured to be capable of directly monitoring the one or more processes and determining whether the one or more processes are alive based on a result of the monitoring.

Furthermore, second monitor 50 monitors whether a memory of a process has been tampered with.

First monitor 40 is software that runs in the trust zone, which is a secure area in hardware 10. First monitor 40 monitors second monitor 50 from a robust area in monitoring system 1. Furthermore, first monitor 40 collects, for example, a monitor log of second monitor 50. That is, first monitor 40 collects a log obtained by second monitor 50 monitoring its monitoring targets.

As described above, monitoring system 1 has a configuration in which first monitor 40 operating in the trust zone being the secure area monitors second monitor 50 arranged in kernel layer 20, and second monitor 50 monitors its monitoring targets operating in the normal world (e.g., the monitoring targets existing in user layer 30). Monitoring system 1 ensures security robustness by forming a chain of monitoring. It should be noted that monitoring system 1 including at least second monitor 50 will suffice, and monitoring system 1 may further include first monitor 40.

It should be noted that first monitor 40 and second monitor 50 are both capable of restarting monitoring system 1. For example, the restart is executed when at least one of first monitor 40 and second monitor 50 is in danger.

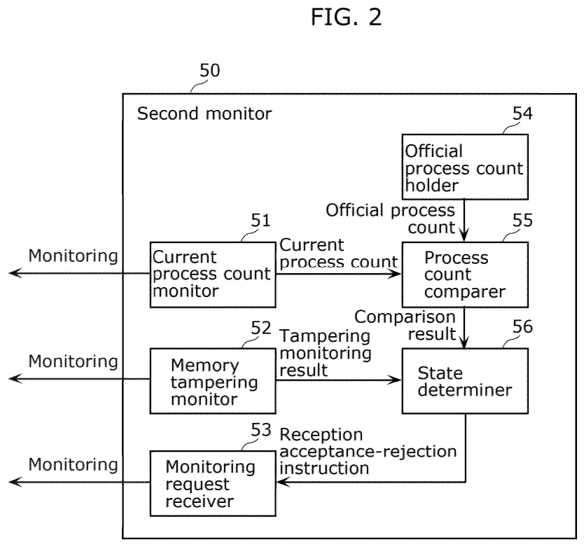

Here, with reference to FIG. 2, a functional configuration of second monitor 50 will be described. FIG. 2 is a block diagram illustrating the functional configuration of second monitor 50 according to the present embodiment.

As illustrated in FIG. 2, second monitor 50 includes current process count monitor 51, memory tampering monitor 52, monitoring request receiver 53, official process count holder 54, process count comparer 55, and state determiner 56.

Current process count monitor 51 monitors a process count of processes currently in operation (e.g., existing) out of one or more processes that are the monitoring targets of second monitor 50 and outputs the process count (e.g., current process count shown in FIG. 2) to process count comparer 55. In a case where the OS of monitoring system 1 is Linux, current process count monitor 51 may obtain the process count by counting the processes currently in operation (e.g., currently existing) based on a result of determining whether each process exists, which is provided as a basic function of Linux.

Memory tampering monitor 52 monitors whether a memory of each of the one or more processes that are the monitoring targets of second monitor 50 has been tampered with and outputs the presence or absence of the tampering (tampering monitoring result shown in FIG. 2) to state determiner 56. Memory tampering monitor 52 obtains first information that is supposed to be unchanged in a memory of the process from corresponding application unit 31 or the like in an initial stage at the beginning of use, obtains second information that corresponds to the first information stored in the memory of each of the one or more processes in corresponding application unit 31 at a current time point, and compares the first information and the second information to determine whether the memory has been tampered with. For example, when the first information and the second information match, memory tampering monitor 52 determines that the memory has not been tampered with, and when the first information and the second information do not match, memory tampering monitor 52 determines that the memory has been tampered with. It can be said that, when the first information is changed, memory tampering monitor 52 determines that the memory has been tampered with, and when the first information is not changed, memory tampering monitor 52 determines that the memory has not been tampered with. It should be noted that the method of determining the presence or absence of tampering with the memory is not limited to the above. Any known method may be used.

Monitoring request receiver 53 obtains, from a monitoring target of second monitor 50, a monitoring request that is a request to execute monitoring of the monitoring target. For example, when management program 32 restarts monitoring system 1 including the monitoring target and a monitoring device (e.g., second monitor 50) based on a result of monitoring the monitoring target, monitoring request receiver 53 obtains the monitoring request from the monitoring target after the restart of that monitoring system 1. In the present embodiment, monitoring request receiver 53 obtains a monitoring request for a process that is output by operation of required function 31a of application unit 31. The monitoring request may include information for identifying a process in application unit 31 that has output the monitoring request. Alternatively, the monitoring request may be, for example, a request to resume monitoring of a process that is a monitoring target of second monitor 50 and has been excluded from monitoring by second monitor 50 due to the restart by management program 32. Monitoring request receiver 53 is an example of an obtainer.

Official process count holder 54 is a storage device that saves a process count of processes to be monitored that is correct according to a specification of monitoring system 1 (official process count shown in FIG. 2). Official process count holder 54 stores a process count of processes being monitoring targets that is predetermined as a specification of monitoring system 1. Furthermore, it can be said that official process count holder 54 stores a process count of processes of the monitoring targets, and the process count is set in advance. Official process count holder 54 is an example of a storage.

In a case where the monitoring targets of second monitor 50 are a plurality of apps, official process count holder 54 stores, as the official process count, a process count that is a total of the numbers of one or more processes of the plurality of apps. The following description will be given assuming that official process count holder 54 stores the process count being M (M is a natural number greater than or equal to 1). M is an example of a first process count. Furthermore, official process count holder 54 outputs the official process count to process count comparer 55 as necessary. Official process count holder 54 is realized by, for example, but not limited to, a semiconductor memory.

Process count comparer 55 compares two process counts and outputs a result of the comparison to state determiner 56. Process count comparer 55 compares the current process count from current process count monitor 51 and the official process count from official process count holder 54 and outputs, to state determiner 56, as a result of the comparison, whether the current process count and the official process count match, or outputs a magnitude relation when the current process count and the official process count do not match. The official process count is an example of a first process count, and the current process count is an example of a second process count.

State determiner 56 determines a state of each process (or monitoring system 1) based on the result of the comparison from process count comparer 55 and the tampering monitoring result from memory tampering monitor 52. The state includes a normal state indicating being normal, a state of attack indicating that the process is under cyberattack from the outside or the like, and a failure state indicating that a failure occurs. The failure here does not include an operational anomaly in the process by a cyberattack. Furthermore, when monitoring request receiver 53 obtains a monitoring request after management program 32 executes the system reset, state determiner 56 determines whether to resume monitoring of the monitoring target based on the result of the comparison between the current process count of the processes being the monitoring targets after the restart and the official process count. State determiner 56 is an example of a first determiner. The first determiner exists in, for example, kernel layer 20.

### [2. Operation of Monitoring System]

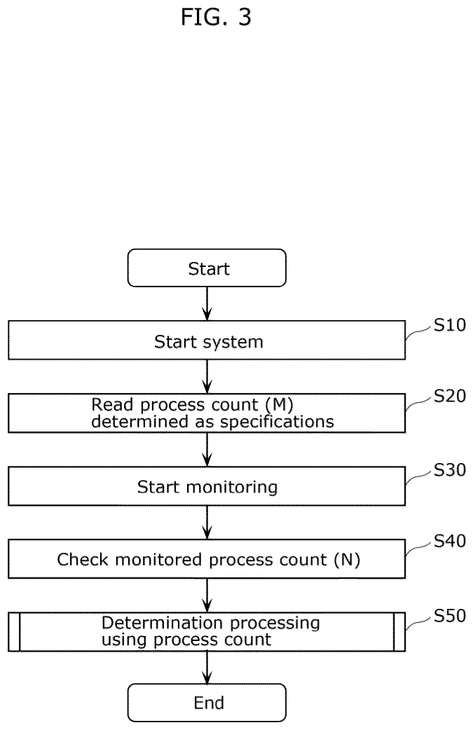

Subsequently, with reference to FIG. 3 to FIG. 5, the operation of monitoring system 1 configured as described above will be described. FIG. 3 is a flowchart illustrating the operation (a monitoring method) of second monitor 50 according to the present embodiment.

As illustrated in FIG. 3, when the system (monitoring system 1) is started (S10), process count comparer 55 first reads a process count (M) that is determined as a specification (S20). The process count (M) means the official process count. The process count read in step S20 is M.

Next, second monitor 50 starts monitoring the monitoring targets (here, the one or more processes of application unit 31) (S30).

Next, current process count monitor 51 checks a process count of monitored processes (N) (S40). Specifically, current process count monitor 51 obtains the process count (N) of processes that are currently alive among the one or more processes being the monitoring targets. For example, current process count monitor 51 obtains information about existing processes by using a basic function provided in Linux and obtains the process count (N) based on the obtained information about the processes. The process count (N) means the current process count. The process count of processes that currently exist in monitoring system 1 is N. N is an example of the second process count. It should be noted that, for example, current process count monitor 51 may periodically check the current process count of the monitoring targets after monitoring system 1 is started.

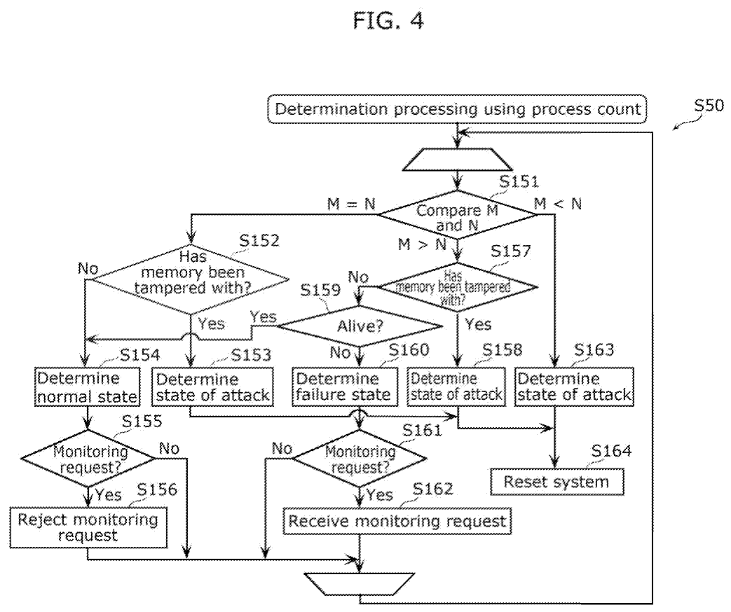

Next, second monitor 50 executes determination process using the process count (S50). Step S50 will be described with reference to FIG. 4. FIG. 4 is a flowchart illustrating the detailed operation (the monitoring method) in step S50 illustrated in FIG. 3. It should be noted that, for example, the operation illustrated in FIG. 4 may be executed on each of one or more application units 31, or the operation illustrated in FIG. 4 may be repeatedly executed on all application units 31.

As illustrated in FIG. 4, process count comparer 55 compares the process counts M and N (S151). Process count comparer 55 determines whether M and N match, and when M and N do not match, process count comparer 55 determines a magnitude relation through the comparison. It should be noted that, in a case where step S151 is executed after management program 32 executes the system reset on monitoring system 1, M is determined to be greater than N because N=0.

Next, when M and N match (M=N in S151) or when M is greater than N (M>N in S151), memory tampering monitor 52 determines whether a memory has been tampered with for all the processes being the monitoring targets (S152, S157). In an example in FIG. 1, only one application unit 31 is illustrated. However, in a case where there are a plurality of application units being monitoring targets of second monitor 50, memory tampering monitor 52 determines whether a memory has been tampered with for one or more processes of each of the plurality of application units.

Next, when M and N match and when memory tampering monitor 52 determines that a memory has been tampered with (Yes in S152), state determiner 56 determines that the state of monitoring system 1 is a state of attack (S153), and executes the system reset (S164). Furthermore, when M and N match and when memory tampering monitor 52 determines that no memory has been tampered with (No in S152), state determiner 56 determines that the state of monitoring system 1 is a normal state (S154).

Next, state determiner 56 determines whether there is a monitoring request from required function 31a (S155), and when there is a monitoring request from a monitoring target (Yes in S155), state determiner 56 rejects the monitoring request (S156). That is, state determiner 56 does not add an application unit that has output the monitoring request (i.e., one or more processes) to the monitoring targets. State determiner 56 outputs a reception rejection instruction to monitoring request receiver 53 as a reception acceptance-rejection instruction (see FIG. 2).

This is because, if the monitoring request is received, the process count of the processes being the monitoring targets exceeds M, and there is a possibility that a spoofing attack is currently taking place. Furthermore, when there is no monitoring request (No in S155), state determiner 56 does not perform particular processing.

As seen from the above, when M and N match, state determiner 56 further determines a state of a monitoring target based on a result of determining whether a memory of the monitoring target has been tampered with. When no memory of the monitoring target has been tampered with, state determiner 56 determines that the state of the monitoring target is the normal state and determines not to resume the monitoring in response to a monitoring request. When a memory of the monitoring target has been tampered with, state determiner 56 determines that the state of monitoring system 1 is the state of attack and executes the system reset on monitoring system 1 (S164).

Furthermore, when M is greater than N and when memory tampering monitor 52 determines that a memory has been tampered with (Yes in S157), state determiner 56 determines that the state of monitoring system 1 is the state of attack (S158), and executes the system reset on monitoring system 1 (S164). Furthermore, when M is greater than N, when no memory has been tampered with, and when a process is no longer alive (M>N in S151, and No in S157 and S159), state determiner 56 determines that a state of the process as the failure state (S160), and when there is a monitoring request from the monitoring request (Yes in S161), state determiner 56 receives the monitoring request from the monitoring target, determining that the process that was in failure has recovered (S162). That is, state determiner 56 adds an app that has output the monitoring request (i.e., one or more processes) to the monitoring targets. State determiner 56 outputs a reception acceptance instruction to monitoring request receiver 53 as the reception acceptance-rejection instruction. Furthermore, when there is no monitoring request (No in S161), state determiner 56 does not perform particular processing. It should be noted that a mechanism that ensures security when the monitoring request is received may be added. For example, state determiner 56 may determine whether a file size of the monitoring target remains unchanged. For example, state determiner 56 may determine to receive the monitoring request when the file size of the monitoring target remains unchanged from that in the initial stage at the beginning of use, and may determine not to receive the monitoring request when the file size of the monitoring target is changed from that in the initial stage at the beginning of use. It should be noted that the method of the determination is not limited to the above. Any known method may be used.

As seen from the above, when M is greater than N, state determiner 56 further determines the state of the monitoring target based on the result of determining whether the memory of the monitoring target has been tampered with. For example, when no memory of the monitoring target has been tampered with, and when the monitoring target is alive (Yes in S159), state determiner 56 determines that the state of the monitoring target is the normal state and determines not to resume the monitoring in response to a monitoring request. Furthermore, for example, when no memory of the monitoring target has been tampered with, and when the monitoring target is not alive, state determiner 56 determines that the state of the monitoring target is the failure state and determines to resume the monitoring in response to a monitoring request.

Furthermore, when N is greater than M (M<N in S151), there is a possibility that a spoofing attack is already taking place, and thus state determiner 56 determines that the state of monitoring system 1 is the state of attack (S163) and executes the system reset (S164). It should be noted that, when N is greater than M, a monitoring request from the monitoring target is rejected. State determiner 56 outputs the reception rejection instruction to monitoring request receiver 53 as the Reception acceptance-rejection instruction.

As seen from the above, second monitor 50 is configured to receive a monitoring request when the condition that M is greater than N, no memory has been tampered with, and the process is in the failure state is satisfied. For example, even when management program 32 executes the system reset on monitoring system 1 to exclude the processes from the monitoring targets of second monitor 50, a monitoring request is received when the condition is satisfied. Thus, the monitoring of the processes can be resumed. Furthermore, when M=N, a monitoring request is not received. Thus, the security of monitoring system 1 can be improved compared with a case where a monitoring request is received irrespective of the result of comparing M and N.

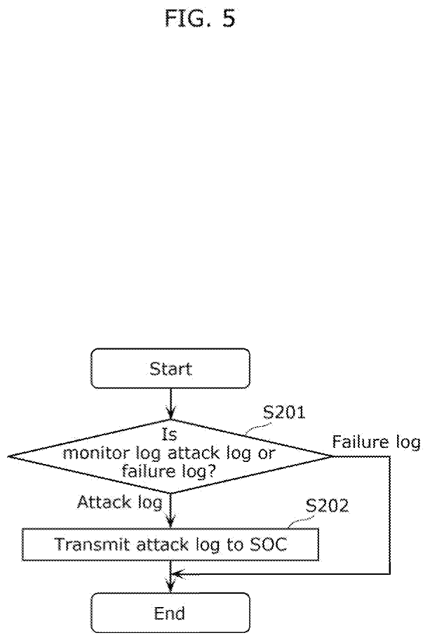

Subsequently, operation of first monitor 40 will be described with reference to FIG. 5. FIG. 5 is a flowchart illustrating other operations (a monitoring method) of first monitor 40 according to the present embodiment.

As illustrated in FIG. 5, first monitor 40 determines whether a monitor log from second monitor 50 is an attack log or a failure log (S201). The monitor log includes, for example, the process count of processes being alive, the presence or absence of tampering with a memory, and the number of restarts of a process. It can be said that first monitor 40 classifies monitor logs into attack logs and failure logs in step S201. For example, first monitor 40 may collect attack logs and failure logs while distinguishing between them.

Next, when a monitor log is an attack log (attack log in S201), first monitor 40 transmits the attack log to a security operation center (SOC) via a communication device provided in the vehicle (S202), and when the monitor log is a failure log (failure log in S201), first monitor 40 finishes the processing. That is, first monitor 40 does not transmit failure logs to the SOC.

As seen from the above, for example, when a monitor log obtained by monitoring the process is an attack log (e.g., when the monitor log is a monitor log obtained when monitoring system 1 is in the state of attack), first monitor 40 transmits the attack log to a monitoring center that monitors an object provided with the monitoring device. It should be noted that the determination of whether a monitor log is an attack log or a failure log is not limited to determination of whether the monitor log is a monitor log obtained when monitoring system 1 is in the state of attack. Whether a monitor log is an attack log or a failure log may be determined by any known method.

The SOC is an example of the monitoring center that remotely monitors the vehicle. Furthermore, first monitor 40 is an example of a second determiner. The second determiner exists in, for example, the trust zone.

Accordingly, since it is possible to prevent an unnecessary log that can become noise in analysis performed at the SOC (e.g., a failure log) from being transmitted to the SOC, the efficiency of analysis at the SOC can be improved.

### Other Embodiments

The monitoring device and the like according to one or more aspects have been described based on the embodiment. However, the present disclosure is not limited to this embodiment. Various variations conceived by those skilled in the art applied to the present embodiment and combinations of constituent components in different embodiments may be included in the present disclosure without departing the scope of the present disclosure.

For example, in the above-described embodiment, the example in which the monitoring device is provided in the vehicle is described. However, this is not limiting. The monitoring device may be provided in a movable body other than a vehicle, such as a railroad vehicle or an aircraft, an electrical apparatus such as a mobile phone or home appliance, or the like.

Furthermore, the monitoring device in the above-described embodiment may be realized by an ECU that is disposed in the vehicle and controls a resource in a zone where the ECU is disposed (what is called a zone ECU) or may be realized by an integrated ECU. The integrated ECU is a central ECU into which a plurality of ECUs are integrated. The integrated ECU is an ECU into which functions that are conventionally provided in separate ECUs are integrated to solve a problem of a development time or costs that increase with an increase in complexity of onboard systems. The integrated ECU is an ECU for which virtualization technology is used to operate a plurality of virtual computers (virtual machines: VM) in one ECU. The zone ECU is connected to, for example, a piece of equipment provided in the vehicle and controls the connected piece of equipment.

Furthermore, in the above-described embodiment, the example in which the other monitoring device includes the program that is executed as the basic function of the OS is described. However, this is not limiting. The other monitoring device may be realized by a monitoring device (monitoring unit) other than the basic function of the OS as long as the other monitoring device monitors the app independently of the second monitor and is capable of executing the system reset.

Furthermore, in the above-described embodiment, the example in which the OS is Linux, and the kernel layer and the user layer are provided in the normal world is described. However, the OS may be an OS other than Linux. In this case, the normal world may be provided with an application layer where the app exists and a hardware abstraction layer (HAL) that is arranged between hardware and the application layer.

Moreover, in the above embodiments, the respective elements may be implemented as dedicated hardware or may be realized by executing a software program suited to the respective elements. Alternatively, the respective elements may be implemented by a program executor such as a CPU or a processor reading out and executing the software program recorded on a recording medium such as a hard disk or a semiconductor memory.

Also, the processing order of executing the steps shown in the flowcharts is a mere illustration for specifically describing the present disclosure, and thus may be an order other than the shown order. Also, one or more of the steps may be executed simultaneously (in parallel) with another step, and one or more of the above steps need not be executed.

Also, the divisions of the functional blocks shown in the block diagrams are mere examples, and thus a plurality of functional blocks may be implemented as a single functional block, or a single functional block may be divided into a plurality of functional blocks, or one or more functions may be moved to another functional block. Also, the functions of a plurality of functional blocks having similar functions may be processed by single hardware or software in a parallelized or time-divided manner.

Furthermore, the monitoring device according to the above embodiments may be implemented as a single device or may be implemented as a plurality of devices. When the monitoring device is implemented as a plurality of devices, the respective elements included in the monitoring device may be allocated to the plurality of devices in any manner. When the monitoring device is implemented as a plurality of devices, the communication method between the plurality of devices is not particularly limited, and may be by wireless communication or wired communication. Furthermore, wireless communication and wired communication may be combined between the devices.

Furthermore, each of the elements described in the above embodiments may be implemented as software, and may be implemented typically as a large-scale integration (LSI), which is an integrated circuit (IC). They may take the form of individual chips, or one or more or all of them may be encapsulated into a single chip. Although referred to as LSI here, the integrated circuit may be referred to as an IC, a system LSI, a super LSI, or an ultra LSI depending on the scale of integration. Moreover, the method of implementation of the elements using an integrated circuit is not limited to application of an LSI. The elements may be implemented by a dedicated circuit (a general-purpose circuit that executes a dedicated program) or a general-purpose processor. It is also possible to use a field programmable gate array (FPGA) that can be programmed after the LSI is manufactured, or a reconfigurable processor in which connection and setting of circuit cells in the LSI can be reconfigured.

The system LSI is a super multifunctional LSI manufactured by integrating a plurality of processing units onto a single chip. Specifically, the system LSI is a computer system configured with a microprocessor, a ROM, and so on. The ROM stores a computer program. The microprocessor operates according to the computer program, so that a function of the system LSI is achieved.

Furthermore, an aspect of the present disclosure may by a computer program for causing a computer to execute each of the characteristic steps included in the monitoring method illustrated in any one of FIG. 3 to FIG. 5.

Furthermore, an aspect of the present disclosure may be a non-transitory computer-readable recording medium having such a program recorded thereon. For example, such a program may be distributed or circulated by being recorded on the recording medium. For example, by installing the distributed program in a device including another processor and causing the processor to execute the program, it is possible to cause the device to execute the respective processes described above.

### Supplementary Notes

The techniques described below are disclosed by the description of the foregoing embodiments.

### (Technique 1)

A monitoring device that monitors a monitoring target that exists in a normal world, wherein the monitoring target is also monitored by an other monitoring device different from the monitoring device, and the monitoring device includes: an obtainer that obtains, when the other monitoring device causes restarting of a system based on a result of monitoring the monitoring target, a monitoring request from the monitoring target after the restarting, the system including the monitoring target and the monitoring device; and a determiner that, in response to receiving the monitoring request, determines whether to resume the monitoring of the monitoring target.

Accordingly, the monitoring target that was excluded from the monitoring by the monitoring device due to the restarting by the other device can be restored as a monitoring target of the monitoring device when the determiner determines to resume the monitoring. Therefore, even when the system is restarted by the other monitoring device, it is possible to prevent the monitoring target from being excluded from the monitoring by the monitoring device.

### (Technique 2)

The monitoring device according to Technique 1, further including: a storage that stores a first process count of the monitoring target, the first process count being is set in advance, wherein the determiner determines whether to resume the monitoring of the monitoring target based on a result of comparing a second process count of the monitoring target after the restarting and the first process count.

Accordingly, it is possible to determine whether to resume the monitoring of the monitoring target based on the process count comparison result.

### (Technique 3)

The monitoring device according to Technique 2, wherein, when the second process count is less than the first process count, the determiner determines whether to resume the monitoring of the monitoring target further based on a result of determining whether a memory of the monitoring target that is no longer being monitored due to the restarting of the system has been tampered with.

Accordingly, when the second process count is less than the first process count, it is possible to resume appropriate monitoring of the monitoring target that is in accordance with the result of determining whether the memory has been tampered with.

### (Technique 4)

The monitoring device according to Technique 3, wherein, when the memory has not been tampered with, the determiner determines to resume the monitoring of the monitoring target that is no longer being monitored due to the restarting of the system.

Accordingly, the monitoring of the monitoring target that is no longer being monitored due to the restarting of the system can be resumed.

### (Technique 5)

The monitoring device according to Technique 3 or 4, wherein, when the memory has been tampered with, the determiner determines a state of attack in which the system is under attack.

Accordingly, the resuming of monitoring when there is a possibility that a spoofing attack, or the like, is taking place can be suppressed. Furthermore, for example, when the system is restarted during a state of attack, the security of the system can be improved.

### (Technique 6)

The monitoring device according to any one of Techniques 2 to 5, wherein, when the second process count and the first process count match, the determiner further determines a state of the monitoring target based on a result of determining whether a memory of the monitoring target has been tampered with.

Accordingly, when the first process count and the second process count match, it is possible to resume appropriate monitoring of the monitoring target that is in accordance with the result of determining whether the memory has been tampered with.

### (Technique 7)

The monitoring device according to Technique 6, wherein, when the memory of the monitoring target has not been tampered with, the determiner determines that the state of the monitoring device is a normal state and determines not to resume the monitoring in response to the monitoring request.

Accordingly, in a case where the second process count will become greater than the first process count when monitoring is resumed, that is, in a case where it is suspected that a spoofing attack is taking place, for example, it is possible to suppress the resumption of monitoring.

### (Technique 8)

The monitoring device according to Technique 6 or 7, wherein, when the memory of the monitoring target has been tampered with, the determiner determines a state of attack in which the system is under attack.

Accordingly, the resuming of monitoring when there is a possibility that a spoofing attack, or the like, is taking place can be suppressed. Furthermore, for example, when the system is restarted during a state of attack, the security of the system can be improved.

### (Technique 9)

The monitoring device according to any one of Techniques 2 to 8, wherein, when the second process count is greater than the first process count, the determiner determines a state of attack in which the system is under attack.

Accordingly, the resuming of monitoring when a spoofing attack, or the like, is already taking place can be suppressed. Furthermore, for example, when the system is restarted during a state of attack, the security of the system can be improved.

### (Technique 10)

The monitoring device according to any one of Techniques 5, 8, and 9, wherein, when under the state of attack, the determiner further determines that a log obtained by monitoring the monitoring target is an attack log, and transmits the attack log to a monitoring center that monitors an object to which the monitoring device is provided.

Accordingly, since it is possible to prevent an unnecessary log that can become noise in analysis performed at the monitoring center from being transmitted to the monitoring center, the efficiency of analysis, and so on, at the monitoring center can be improved.

### (Technique 11)

The monitoring device according to any one of Techniques 1 to 10, wherein the other monitoring device is realized by a monitoring function of an OS that operates on the system.

Accordingly, when the system is restarted by the function of the OS, it is possible to present the monitoring target from being excluded from the monitoring by the monitoring device.

### (Technique 12)

A monitoring method executed by a monitoring device that monitors a monitoring target that exists in a normal world, wherein the monitoring target is also monitored by an other monitoring device different from the monitoring device, and the monitoring method includes: obtaining, when the other monitoring device causes restarting of a system based on a result of monitoring the monitoring target, a monitoring request from the monitoring target after the restarting, the system including the monitoring target and the monitoring device; and in response to receiving the monitoring request, determining whether to resume the monitoring of the monitoring target.

Accordingly, an advantageous effect that is the same as that of the above-described monitoring device is produced.

### (Technique 13)

A non-transitory computer-readable recording medium having recorded thereon a program for causing a computer to execute the monitoring method according to Technique 12.

Accordingly, an advantageous effect that is the same as that of the above-described monitoring device is produced.

### Further Information about Technical Background to this Application

The disclosures of the following patent applications including specification, drawings, and claims are incorporated herein by reference in their entirety: Japanese Patent Application No. 2024-012692 filed on Jan. 31, 2024 and Japanese Patent Application No. 2024-090876 filed on Jun. 4, 2024.

### INDUSTRIAL APPLICABILITY

The present application is useful to a monitoring device, or the like, that monitors a monitoring target such as an application.

1. A monitoring device that monitors a monitoring target that exists in a normal world,
wherein the monitoring target is also monitored by an other monitoring device different from the monitoring device, and
the monitoring device comprises:
an obtainer that obtains, when the other monitoring device causes restarting of a system based on a result of monitoring the monitoring target, a monitoring request from the monitoring target after the restarting, the system including the monitoring target and the monitoring device; and
a determiner that, in response to receiving the monitoring request, determines whether to resume the monitoring of the monitoring target.

2. The monitoring device according to claim 1, further comprising:
a storage that stores a first process count of the monitoring target, the first process count being is set in advance, wherein
the determiner determines whether to resume the monitoring of the monitoring target based on a result of comparing a second process count of the monitoring target after the restarting and the first process count.

3. The monitoring device according to claim 2, wherein
when the second process count is less than the first process count, the determiner determines whether to resume the monitoring of the monitoring target further based on a result of determining whether a memory of the monitoring target that is no longer being monitored due to the restarting of the system has been tampered with.

4. The monitoring device according to claim 3, wherein
when the memory has not been tampered with, the determiner determines to resume the monitoring of the monitoring target that is no longer being monitored due to the restarting of the system.

5. The monitoring device according to claim 3, wherein
when the memory has been tampered with, the determiner determines a state of attack in which the system is under attack.

6. The monitoring device according to claim 2, wherein
when the second process count and the first process count match, the determiner further determines a state of the monitoring target based on a result of determining whether a memory of the monitoring target has been tampered with.

7. The monitoring device according to claim 6, wherein
when the memory of the monitoring target has not been tampered with, the determiner determines that the state of the monitoring device is a normal state and determines not to resume the monitoring in response to the monitoring request.

8. The monitoring device according to claim 6, wherein
when the memory of the monitoring target has been tampered with, the determiner determines a state of attack in which the system is under attack.

9. The monitoring device according to claim 2, wherein
when the second process count is greater than the first process count, the determiner determines a state of attack in which the system is under attack.

10. The monitoring device according to claim 5, wherein
when under the state of attack, the determiner further determines that a log obtained by monitoring the monitoring target is an attack log, and transmits the attack log to a monitoring center that monitors an object to which the monitoring device is provided.

11. The monitoring device according to claim 8, wherein
when under the state of attack, the determiner further determines that a log obtained by monitoring the monitoring target is an attack log, and transmits the attack log to a monitoring center that monitors an object to which the monitoring device is provided.

12. The monitoring device according to claim 9, wherein
when under the state of attack, the determiner further determines that a log obtained by monitoring the monitoring target is an attack log, and transmits the attack log to a monitoring center that monitors an object to which the monitoring device is provided.

13. The monitoring device according to claim 1, wherein
the other monitoring device is realized by a monitoring function of an operating system (OS) that operates on the system.

14. A monitoring method executed by a monitoring device that monitors a monitoring target that exists in a normal world,
wherein the monitoring target is also monitored by an other monitoring device different from the monitoring device, and
the monitoring method comprises:
obtaining, when the other monitoring device causes restarting of a system based on a result of monitoring the monitoring target, a monitoring request from the monitoring target after the restarting, the system including the monitoring target and the monitoring device; and
in response to receiving the monitoring request, determining whether to resume the monitoring of the monitoring target.

15. A non-transitory computer-readable recording medium having recorded thereon a program for causing a computer to execute the monitoring method according to claim 14.
